(19) United States
(12) Patent Application Publication
(10) Pub. No.: US 2011/0258058 A1
(43) Pub. Date: Oct. 20, 2011

(54) SYSTEM AND METHOD FOR GENERATING A RESTAURANT ORDER ON A WIRELESS MOBILE PERSONAL COMPUTER

(75) Inventors: Roger D. Carroll, Downers Grove, IL (US); Aaron Randall Ferber, Chicago, IL (US); Kathy Fox, Westmont, IL (US); Mark Alexander Jones, Evanston, IL (US); Stina Maria Jonsson, Chicago, IL (US); Hyun Jin Ko, Evanston, IL (US); Eleanor Elizabeth Luna, Chicago, IL (US); Jeff Pollard, Plainfield, IL (US); Carley Rachel Price, Evanston, IL (US); Paul Price, McHenry, IL (US); Melody Roberts, Chicago, IL (US); Jon Vernon Wettersten, Chicago, IL (US)

(73) Assignee: Restaurant Technology, Inc., St. Charles, IL (US)

(21) Appl. No.: 12/760,534

(22) Filed: Apr. 14, 2010

(51) Int. Cl. G06Q 50/00; G06Q 30/00

(52) U.S. Cl. 705/15

(57) ABSTRACT

A wireless mobile personal computer is provided for enabling a customer to generate a restaurant order on the wireless mobile personal computer. The wireless mobile personal computer includes a restaurant order generating application configured to generate restaurant item selecting interface screens for generating the restaurant order comprising at least one restaurant item, to generate a machine-readable representation of the generated restaurant order, a processor for executing the restaurant order generating application, a memory for storing the restaurant order generating application and selectable restaurant items, and a display for displaying the restaurant item selecting interface screens, and the at least one restaurant item.

### TECHNICAL FIELD

This invention relates generally to systems and methods for generating and placing orders in a quick service restaurant environment. More particularly, the present invention relates to a system, method and apparatus that enable a customer to generate a quick service restaurant order, and an optical machine-readable or radio transmittable representation of the generated restaurant order on a wireless mobile personal computer.

### BACKGROUND OF THE INVENTION

This invention relates generally to restaurant order generating apparatuses. Prior order generating wireless devices systems have been attempted and implemented. One such system is disclosed within U.S. Pat. No. 6,366,220 B1, to Brig Barnum Elliott, issued on Apr. 2, 2002, is directed to a system and method for allowing a customer to order drive-through menu items using a customer vehicle equipped with the radio frequency (RF) tag. Prior to placing an order, the customer opens an account and creates a default menu using a food vendor's web site. To order items from the default menu, the customer approaches a drive-through order station at a fast food vendor location. As the customer vehicle passes the order station a first transponder queries the RF tag and processes a return signal. Identification information is extracted from return signal such that the customer's order, consisting of the default menu items, is prepared. The customer's vehicle then approaches pick-up station and a second transponder queries the RF tag and subsequently bills the customer's account for the ordered items. U.S. Pat. No. 6,366,220 B1 is incorporated herein by reference for at least the purpose of giving context to the present invention.

U.S. Patent Publication No. 2007/0291710 A1 to Anthony M. Fadell is directed to a wireless communication system. The wireless communication system includes a wireless communication interface that wirelessly communicates with one or more wireless client devices in the vicinity of an establishment. The wireless communication interface receives a remote order corresponding to an item selected by at least one of the wireless client devices. A local server computer located in proximity to the establishment generates instructions for processing the remote order received from the wireless communication interface. The local server computer then passes the processing instructions to an order processing queue in preparation for processing of the remote order. U.S. Patent Publication No. 2007/0291710 A1 is incorporated herein by reference for at least the purpose of giving context to the present invention.

However, the prior systems and methods are unable to communicate restaurant orders generated on wireless devices to vending establishments which are not capable, either temporarily or permanently, to handle wireless communications with the wireless devices. Despite the advances of the wireless communication technology, the quick service restaurant (QSR) industry is in need of less cost intensive and more efficient wireless order placements.

### SUMMARY OF THE INVENTION

The present invention is defined by the appended claims. This description summarizes some aspects of the present embodiments and should not be used to limit the claims.

The foregoing problems are solved and a technical advance is achieved by a system, method, and articles of manufacture consistent with the present invention, which enable a customer to generate a restaurant order on a wireless mobile personal computer.

One embodiment of the present invention is directed to a wireless mobile personal computer for enabling a customer to generate a restaurant order on the wireless mobile personal computer, comprising a restaurant order generating application configured to generate restaurant item selecting interface screens for generating the restaurant order comprising at least one restaurant item, to generate a machine-readable or radio transmittable representation of the generated restaurant order, a processor for executing the restaurant order generating application, a memory for storing the restaurant order generating application and selectable restaurant items, and a display for displaying the restaurant item selecting interface screens, the at least one restaurant items. The machine-readable representation of the generated order is an optical machine-readable representation. The machine-readable representation of the generated order is radio transmittable representation.

Another embodiment of the present invention is directed to a computer readable medium encoded with a restaurant order generating computer program application configured to generate a restaurant order on a wireless mobile personal computer, the wireless mobile personal computer having a processor for executing the restaurant order generating application, a memory for storing the restaurant order generating application and selectable restaurant items, and a display. The restaurant order generating computer program application comprises a first code segment for generating restaurant item selecting interface screens, a second code segment for receiving a selection of at least one restaurant item, a third code segment for generating a restaurant order from the selection of the at least one restaurant item, a fourth code segment for generating a machine-readable representation of the generated restaurant order.

Another embodiment of the present invention is directed to a system for enabling a customer to generate an order, which comprises a wireless mobile personal computer, a customer kiosk, and a vendor system. The wireless mobile personal computer, which enables the customer to generate a restaurant order on the wireless mobile personal computer, comprises a restaurant order generating application configured to generate restaurant item selecting interface screens for generating the restaurant order comprising at least one restaurant item and to generate a machine-readable representation of the generated restaurant order, a processor for executing the restaurant order generating application, a memory for storing the restaurant order generating application and selectable restaurant items, and a display for displaying the restaurant item selecting interface screens, the at least one restaurant items, and the optical machine-readable representation. The customer kiosk comprises a display, and a scanner and/or an RFID receiver. The scanner comprises a scanning application configured to scan and capture the optical machine-readable representation, a processor for executing the scanning application, and a memory for storing the scanning application. The RFID receiver comprises an RFID detecting application, a processor for executing the detecting application, and a memory for storing the detecting application. The vendor system, which is in communication with the customer kiosk, comprises an account establishing application configured to establish a customer account, a processor for executing the account establishing application, a memory for storing the account establishing application, and a database for storing customer accounts.

Other systems, methods, articles of manufacture, features, and advantages of the present invention will be, or will become, apparent to one having ordinary skill in the art upon examination of the following drawings and detailed description. It is intended that all such additional systems, methods, articles of manufacture, features, and advantages included within this description, be within the scope of the present invention, and be protected by the accompanying claims.

### BRIEF DESCRIPTION

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

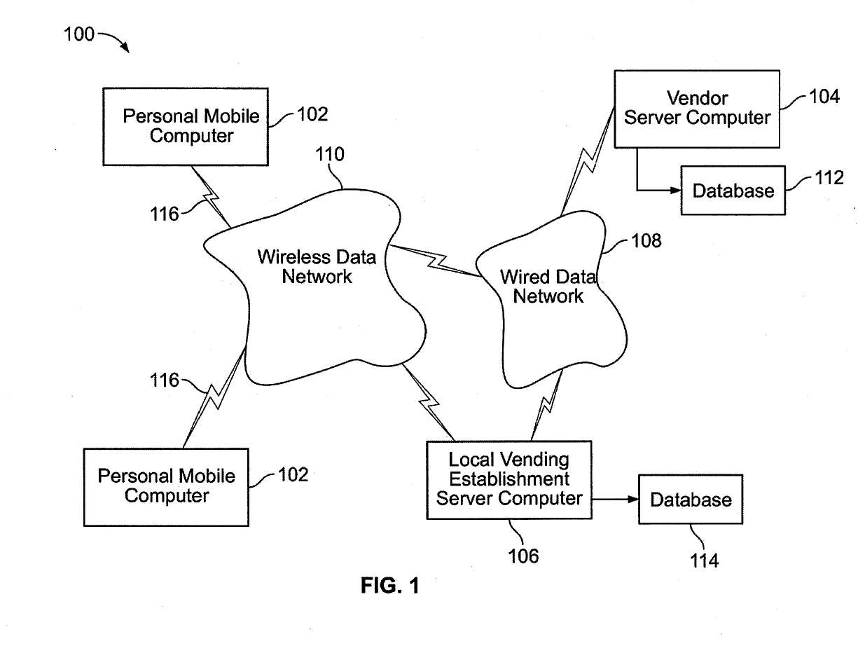

FIG. 1 is a system diagram illustrating an embodiment of a computer networked system in accordance with the invention;

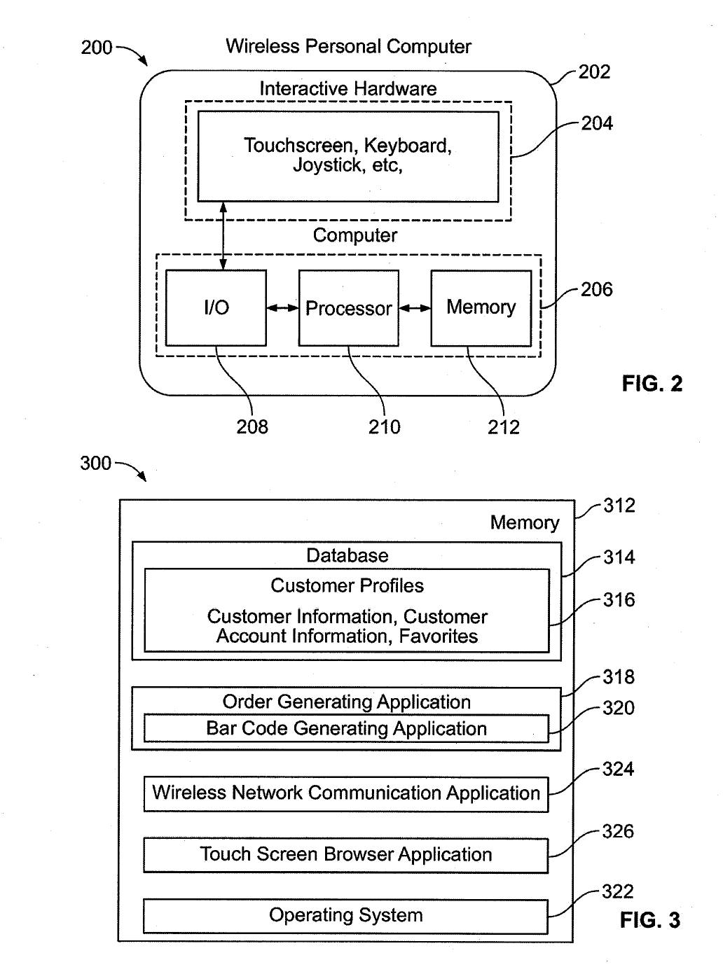

FIG. 2 is a schematic diagram of a handheld electronic device;

FIG. 3 is a schematic diagram of a memory portion of the handheld electronic device of FIG. 2;

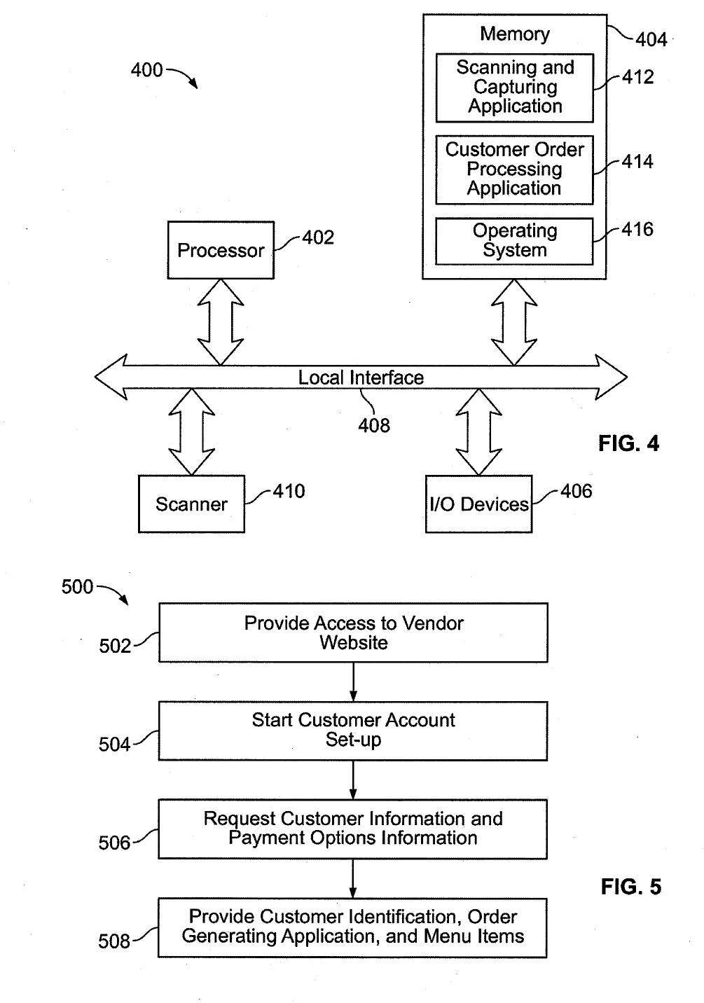

FIG. 4 is a block diagram illustrating a customer kiosk computer system;

FIG. 5 is a flow chart illustrating an embodiment of a process for establishing a customer account with a vendor in accordance with the invention;

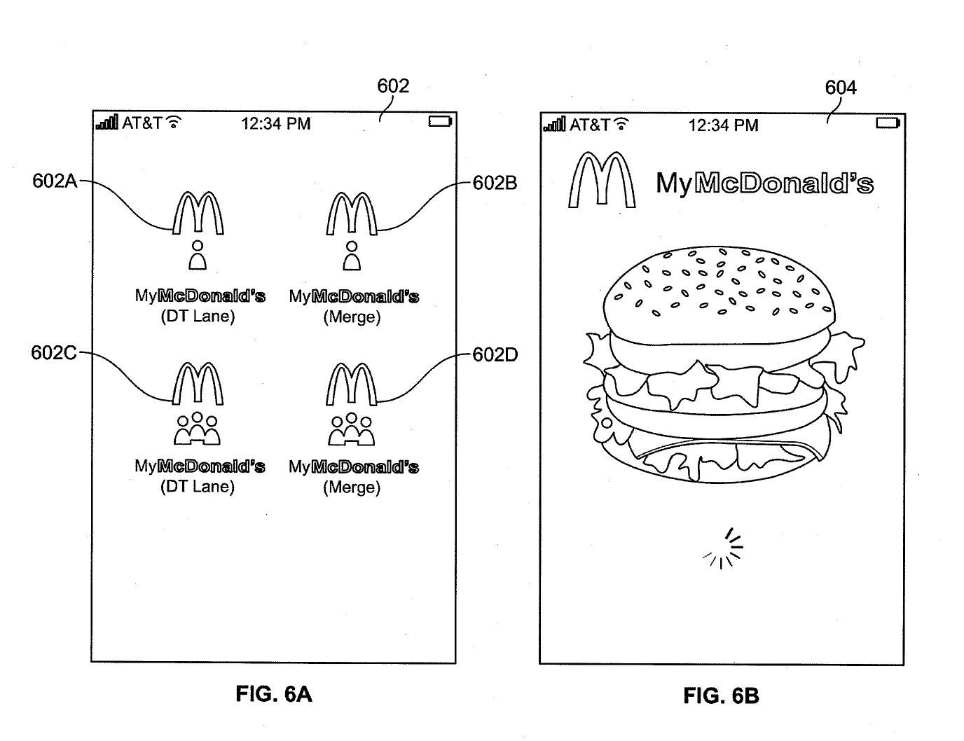

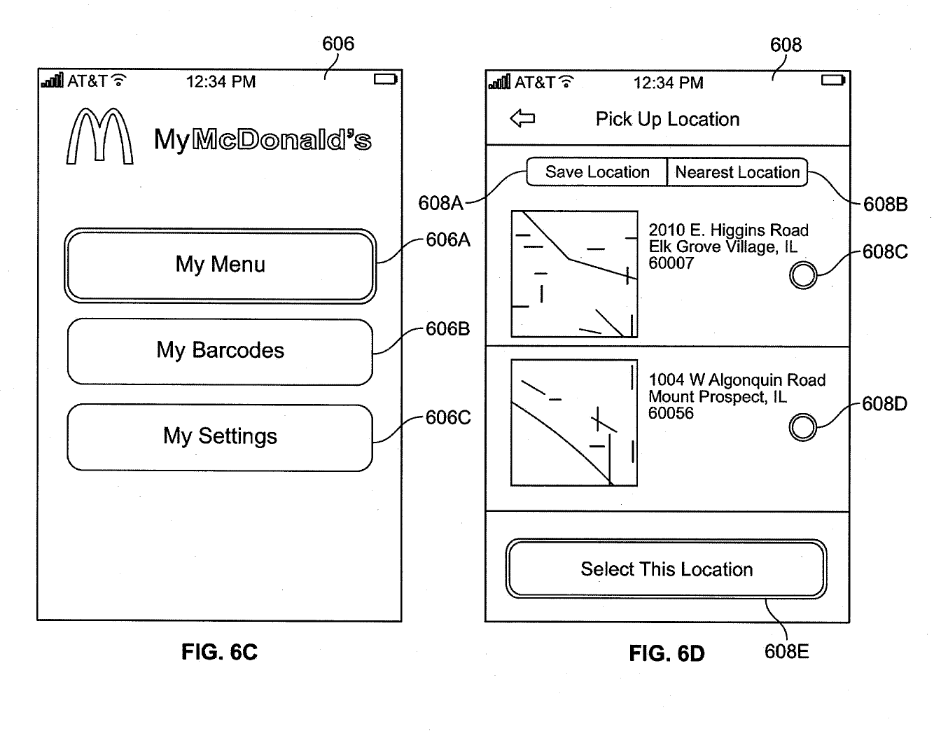

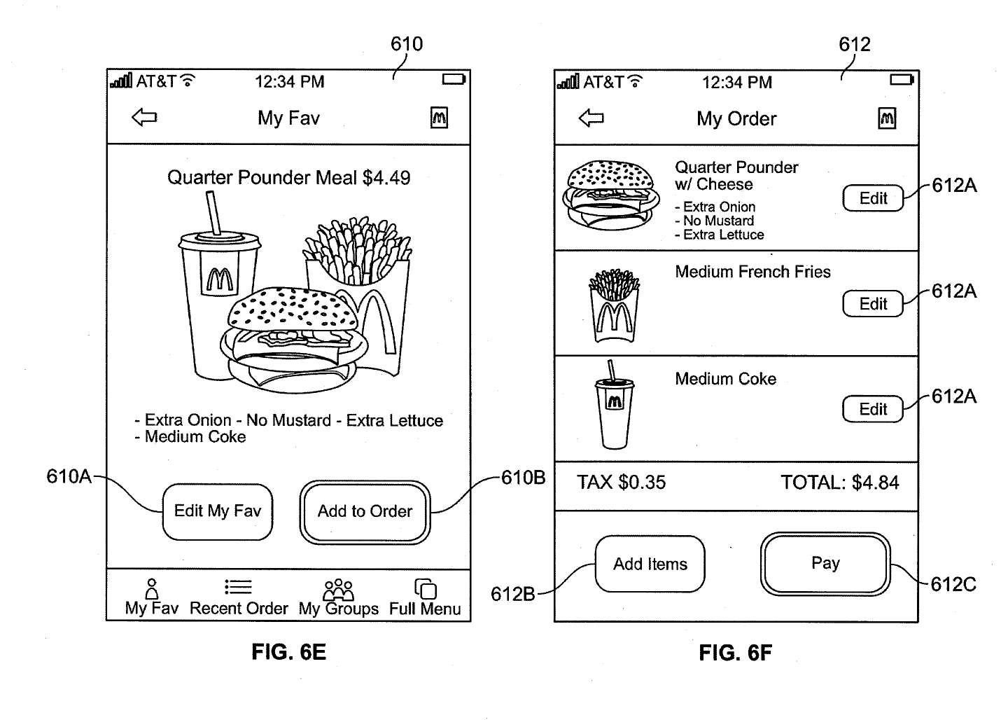

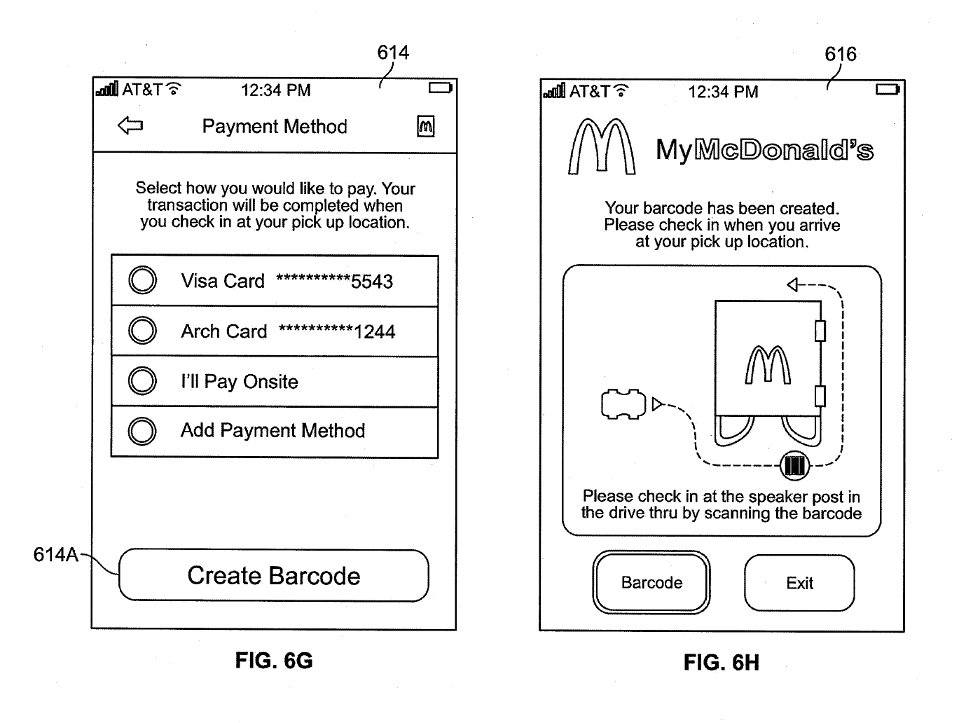

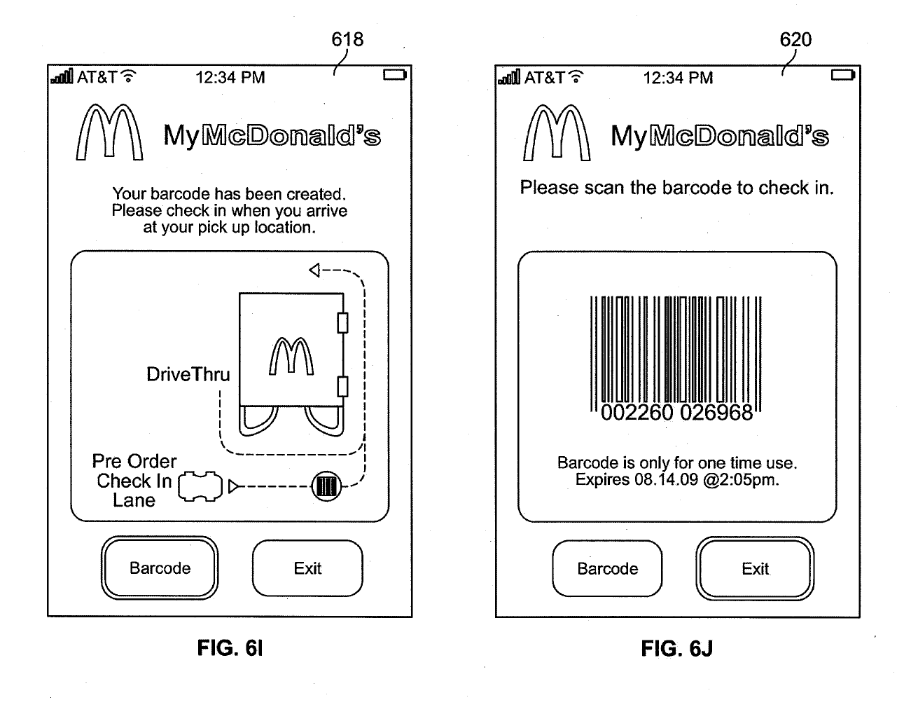

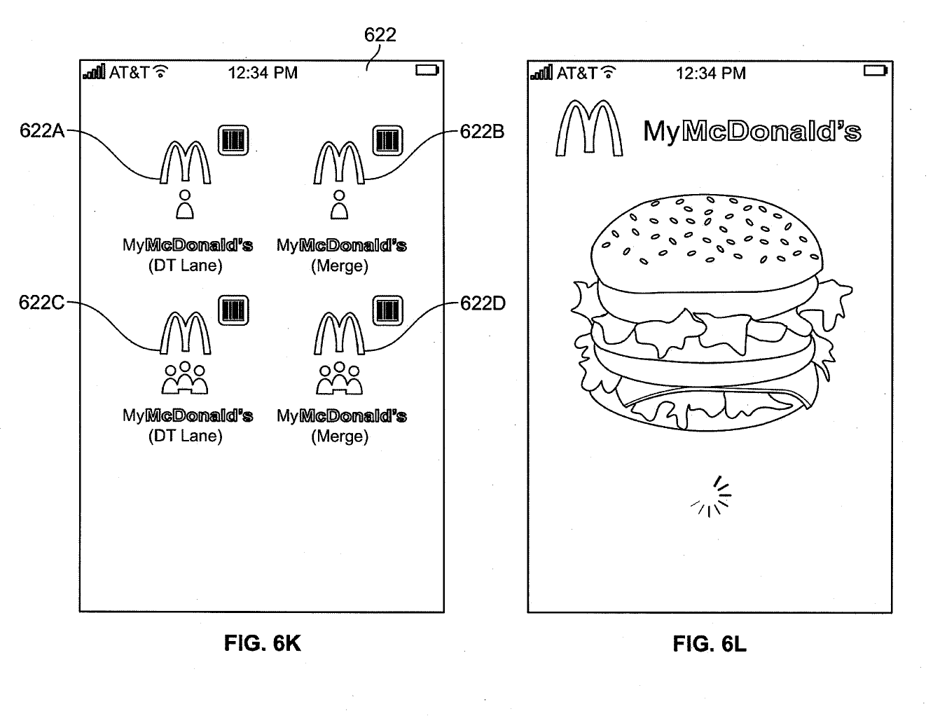

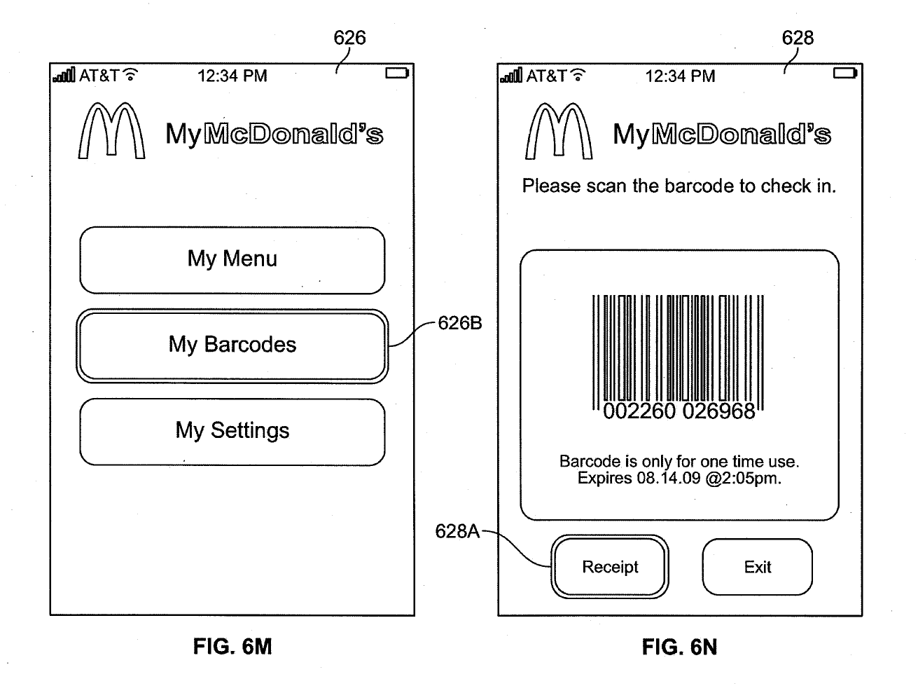

FIGS. 6A-6O illustrates customer ordering interface screens displayed on the display of the wireless mobile personal computer and representing a single order option in accordance with the invention;

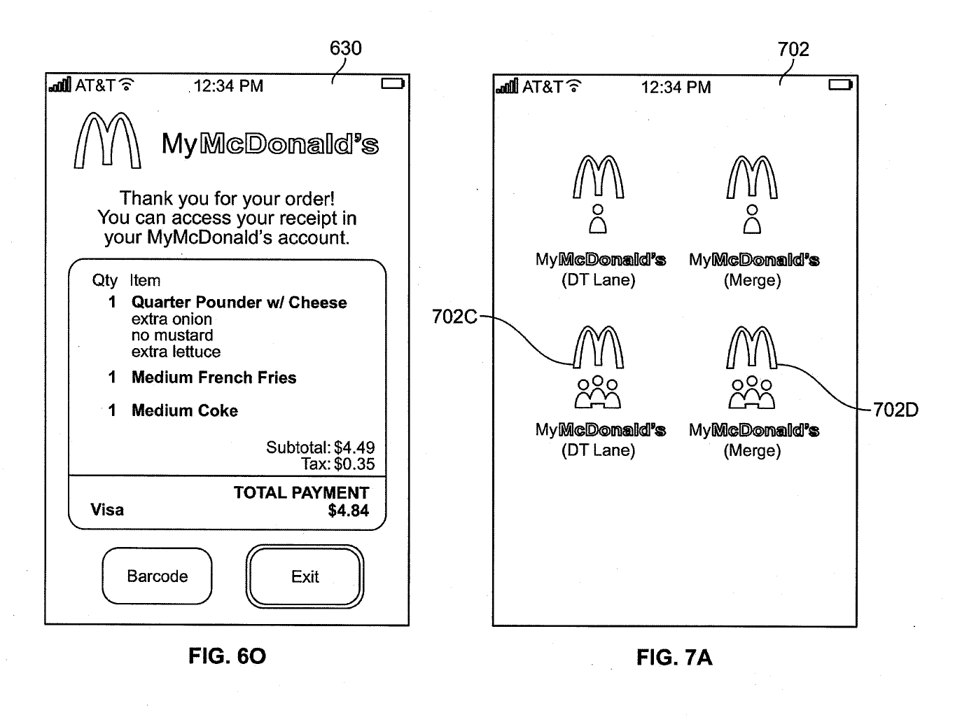

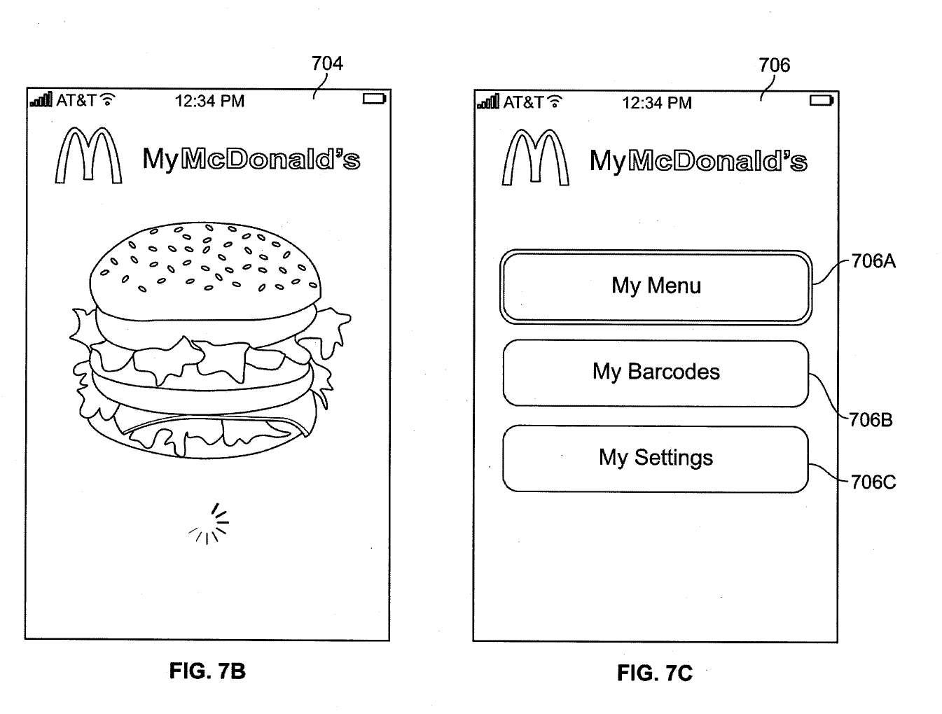

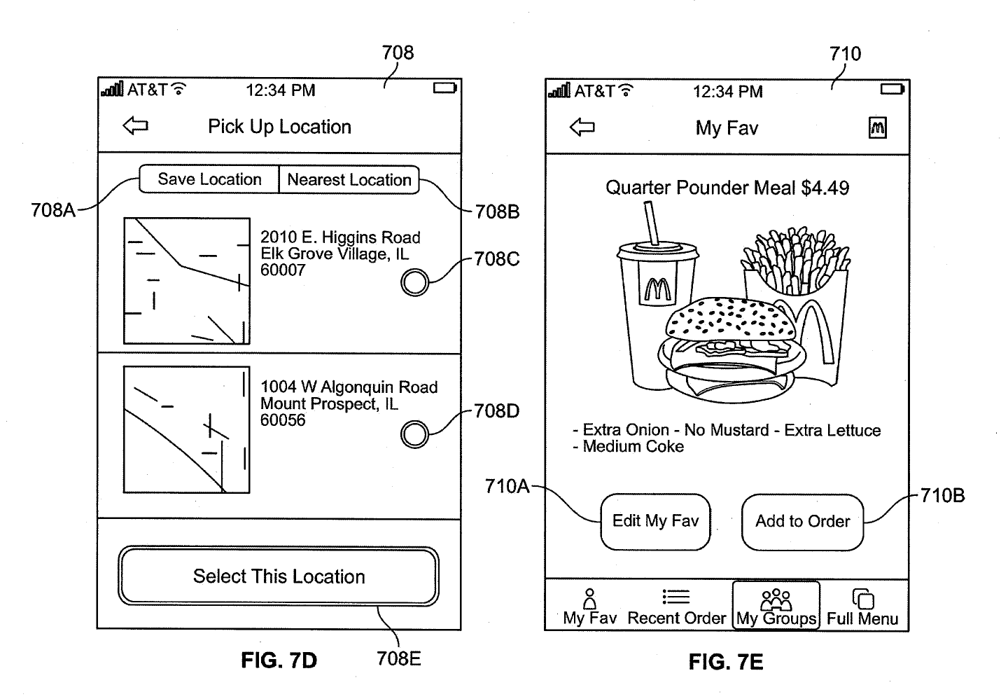

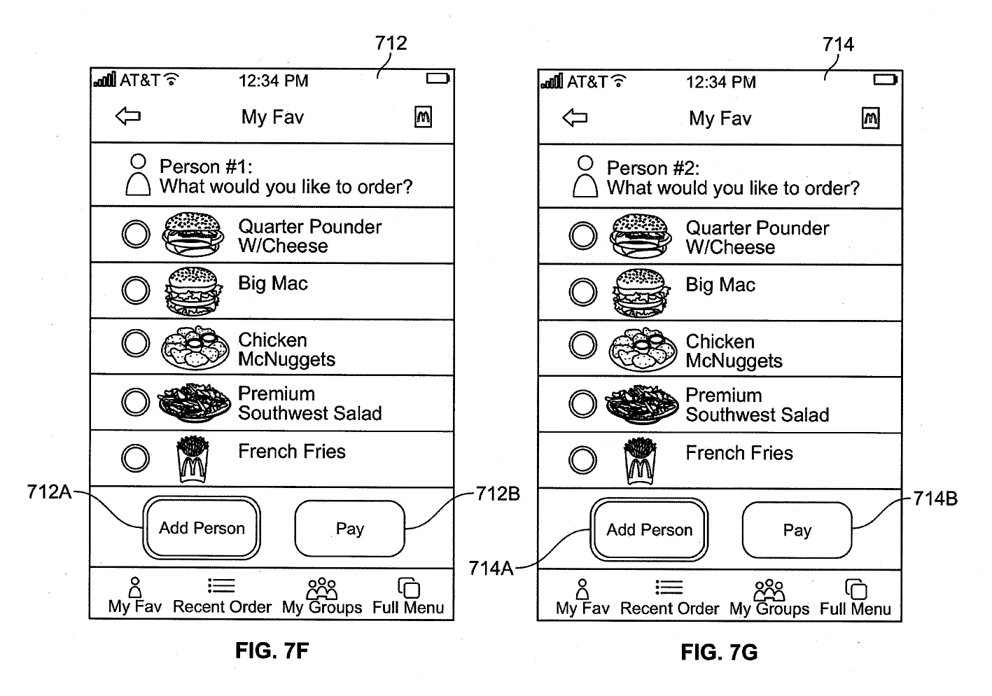

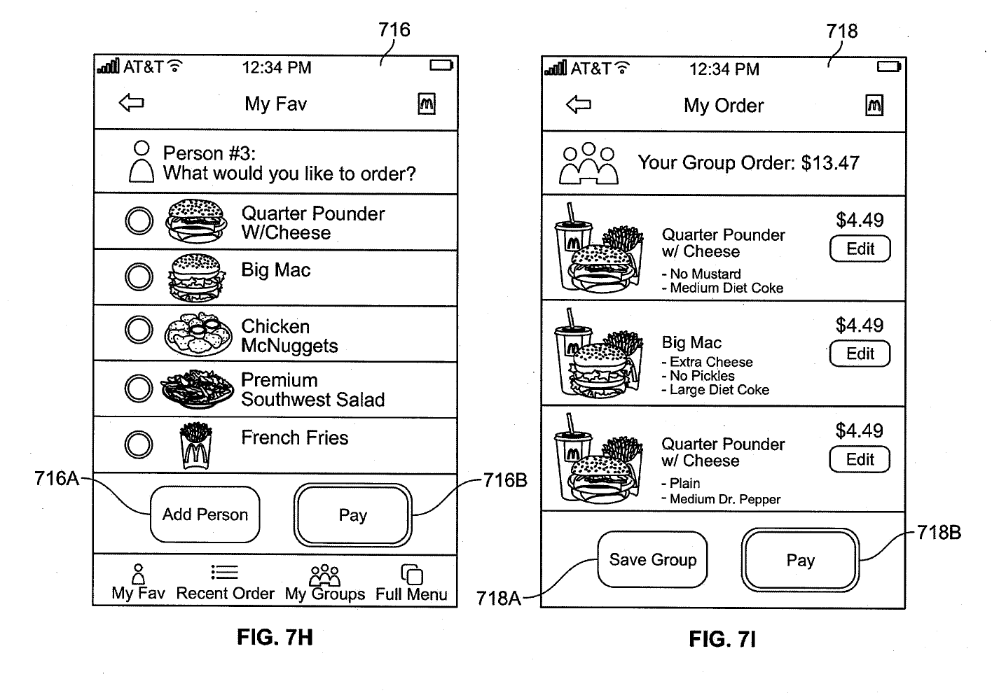

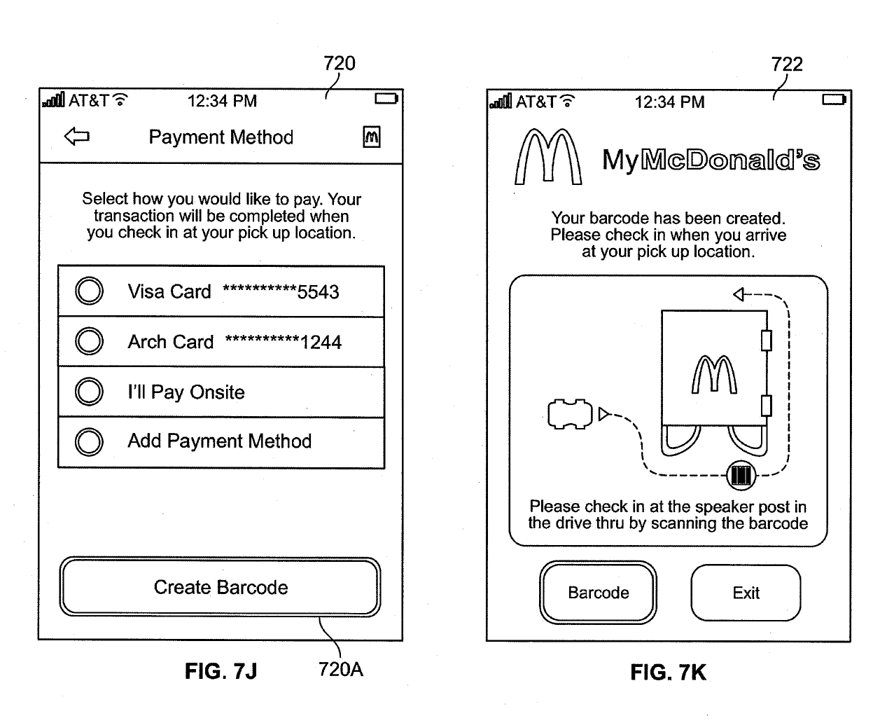

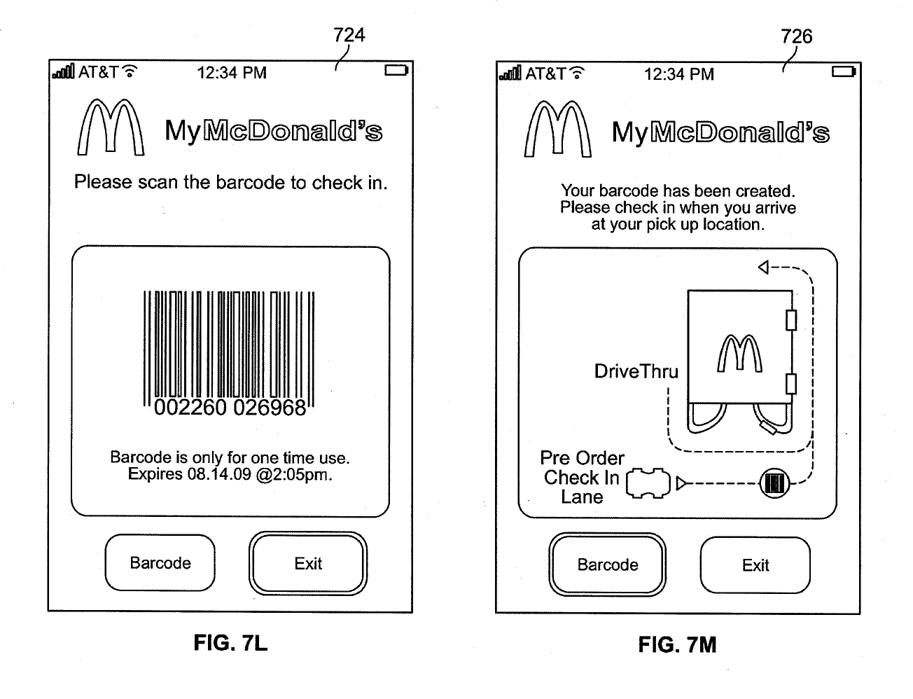

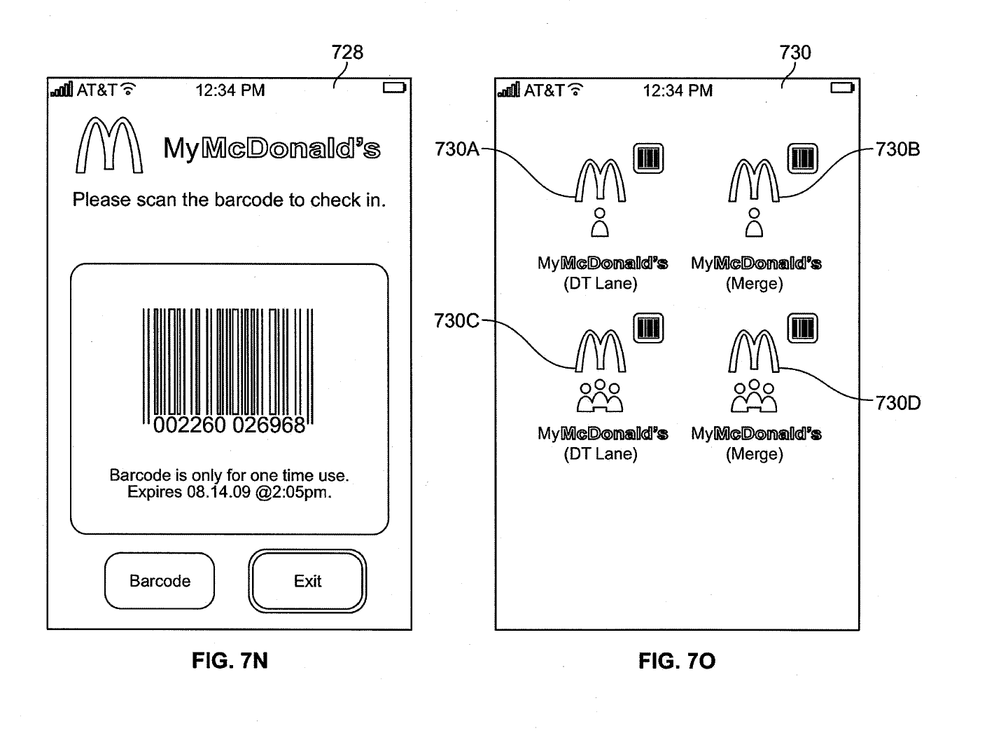

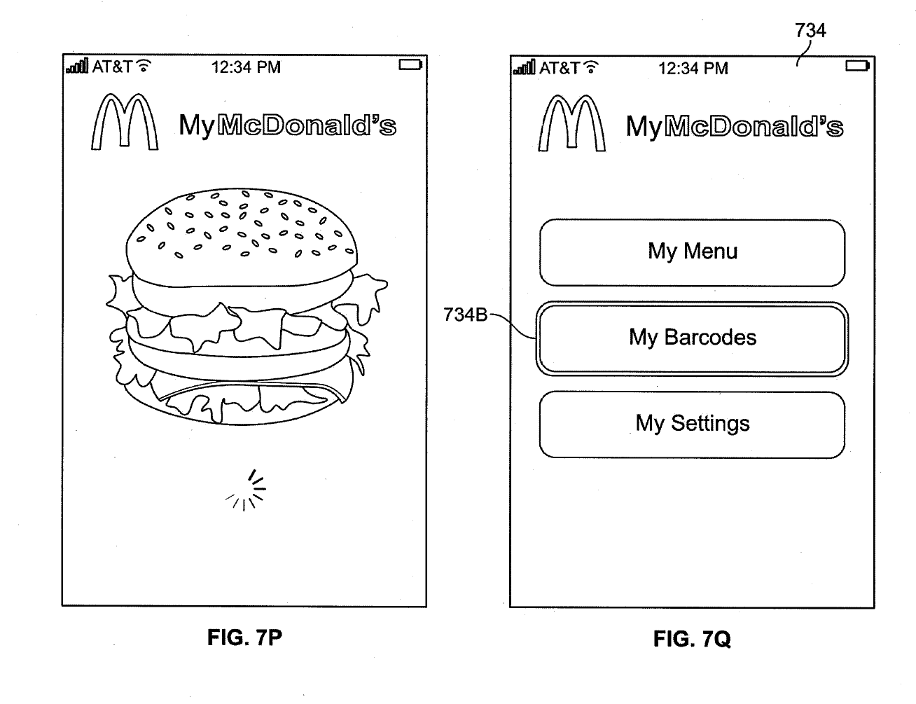

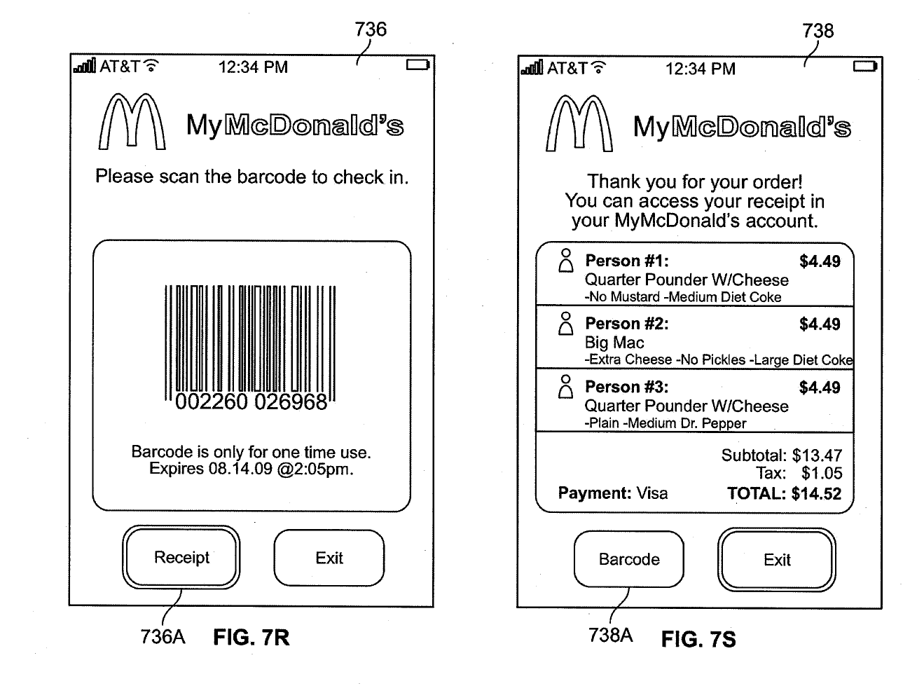

FIGS. 7A-7S illustrates customer ordering interface screens for a group order option in accordance with the invention; and

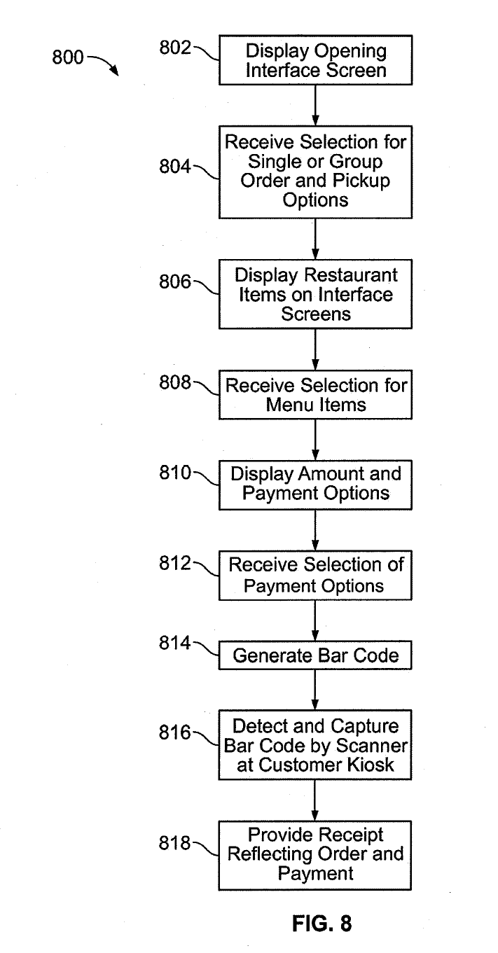

FIG. 8 is a flowchart illustrating an embodiment for generating a restaurant order and on a wireless mobile personal computer in accordance with the invention.

Illustrative and exemplary embodiments of the invention are described in further detail below with reference to and in conjunction with the figures.

### DETAILED DESCRIPTION OF THE DRAWINGS

The present invention is defined by the appended claims. This description summarizes some aspects of the present embodiments and should not be used to limit the claims.

While the present invention may be embodied in various forms, there is shown in the drawings and will hereinafter be described some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

Referring to FIG. 1, a system diagram illustrates an embodiment of a computer networked system 100 for generating a restaurant order on a wireless mobile personal computer. The computer networked system 100 includes a plurality of wireless mobile personal computers 102, a vendor server computer 104, a local vending establishment server computer 106, a local database 114, a wired data network 108 and a wireless data network 110. The wired data network 108 can be a global network, a wide area network or a local area network. The wireless data network 110, which can couple to the wired data network 108, can include one of more wireless data networks, such as cellular networks, WiFi networks, Bluetooth networks, etc. . . . The vendor server computer 104 can couple to the wired data network 108, and the local vending establishment server computer 106 can couple to both the wired data network 108 and the wireless data network 110. The wireless mobile personal computers 102 can couple to the wireless data network 110 over wireless links 116. In this regard, the wireless mobile personal computers 102 can access the vendor server computer 104 and/or the local vending establishment server computer 104 through the wireless data network 110. The wired data network 108 and the wireless data network 110 pertain to some portions of the World Wide Web (WWW, hereafter referred to as Web) and the Internet.

Now referring to FIG. 2, a diagram 200 illustrates schematically one of the wireless mobile personal computers 102 of FIG. 1. The illustrated wireless mobile personal computer 202 is preferably a handheld digital device of palm size or smaller, and can be a personal digital assistant (PDA), a cellular phone, a hybrid between a cellular phone and a PDA, a smart phone such as an IPHONE (3G, 3GS or other versions), or any other handheld electronic device having a display screen. The wireless mobile personal computer 202 includes an interactive hardware portion 204 and a computer portion 206. The interactive hardware portion 204 can include one or more of a touch screen, a keyboard, a stylus, a joystick, and the like, which can be arranged in various manners and have different shapes without changing the spirit of the interaction of the hardware portion 204 with the I/O portion 208. The touch screen can a liquid display crystal (LCD), display screen, a plasma screen, a light emitting diode (LED), or any other screen capable of displaying text and images. The computer portion 206 includes an input/output (I/O) portion 208, a central processing unit (CPU) portion 210, i.e., a microprocessor, and a memory 212. The CPU portion 210 can be any computer-processing unit from a singular microchip to extensive microchip configurations. The memory portion 212 can include, without limitation, any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory portion 212 may incorporate electronic, magnetic, optical, and/or other types of storage media, and can have a distributed architecture where various components are situated remote from one another, but are still accessed by microprocessor portion 210. The interactive hardware portion 204 is coupled to the I/O portion 208 such that a command entered by a user or customer through the interactive hardware portion 204 will be forwarded to the I/O portion 208, to the processor portion 210 and then to memory portion 212.

As illustrated in FIG. 3, a schematic diagram 300 of the memory portion 212 of FIG. 2 is shown. The memory portion 312 can include or store a database 314, executable programs 318, 324 and 326 and an operating system 322. The database 314 can store data related to customer profiles 316, which can include customer information, customer account information, and restaurant favorites. The executable programs 318 can include a restaurant order generating code segment or application 318, a barcode generating application 320, an radio frequency identification (RFID) signal generating application 321, a wireless network communication software application 324, and a touch screen browser software application 326, each stored within the memory portion 312 or other computer hardware device, for operating in connection with the microprocessor portion 210 or other hardware device. For the sake of simplicity, the barcode generating application 320 and the RFID signal generating application 321 are considered to be sub code segments or parts of the restaurant order generating application 318. The executable programs 318 can be implemented in software, firmware, hardware, or a combination thereof. An example of a suitable commercially available operating system 322 is an appliance-based operating system, such as that implemented in handheld computers or personal digital assistants (PDAs) (e.g., PalmOS available from Palm Computing, Inc., IPHONE/IPOD OS available from Apple, and Windows CE available from Microsoft Corporation). The operating system 322 essentially controls the execution of other computer programs, such as the restaurant order generating application 318, and provides scheduling, input-output control, file and data management, memory management, and communication control and related services.

When the wireless mobile personal computer 102 is in operation, the CPU portion 210 is configured to execute software stored within the memory 212, 312, to communicate data to and from memory 212, 312, and to generally control operations of wireless mobile personal computer 102 pursuant to the software. The customer order generating application 318, and the operating system 322, in whole or in part, but typically the latter, are read by the CPU portion 210, perhaps buffered within the CPU portion 210, and then executed. When the customer order generating application 318 is implemented in software, it can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The customer order generating application 318 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory. In another embodiment, where the customer order generating application 318 is implemented in hardware, it can be implemented with any, or a combination of, the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Now referring to FIG. 4, a block diagram illustrates a customer kiosk computer system 400. Generally, in terms of hardware architecture, the customer kiosk computer system 400 includes a processor 402, a memory 404, one or more input and/or output (I/O) devices 406 (or peripherals) that are communicatively coupled via a local interface 408, a scanner 410, and an RFID signal receiver or reader 411. The local interface 408 can be, for example, but not limited to, one or more buses or other wired or wireless connections, as is known in the art. The local interface 408 may have additional elements, which are omitted for simplicity, such as controllers, buffers (caches), drivers, repeaters, and receivers, to enable communications. Further, the local interface 408 may include address, control, and/or data connections to enable appropriate communications among the other computer components.

The processor 402 is a hardware device for executing software, particularly software stored in memory 404. The processor 402 can be any custom made or commercially available processor, a central processing unit (CPU), an auxiliary processor among several processors associated with the customer kiosk computer system 400, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80x86 or Pentium series microprocessor from Intel Corporation, a PowerPC microprocessor from IBM, a Sparc microprocessor from Sun Microsystems, Inc., or a 68xxx series microprocessor from Motorola Corporation. The processor 402 may also represent a distributed processing architecture such as, but not limited to, SQL, Smalltalk, APL, KLisp, Snobol, Developer 200, MUMPS/Magic.

The memory 404 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory 404 may incorporate electronic, magnetic, optical, and/or other types of storage media. Memory 404 can have a distributed architecture where various components are situated remote from one another, but are still accessed by the processor 402.

The software in memory 404 may include one or more separate programs. The separate programs comprise ordered listings of executable instructions for implementing logical functions. In the example of FIG. 4, the software in memory 404 includes a scanning and capturing application 412, a detecting and capturing application 413, an order processing application 414, and a suitable operating system (O/S) 416. A non-exhaustive list of examples of suitable commercially available operating systems 416 is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Palm Computing, Inc., and Windows CE available from Microsoft Corporation). The operating system 416 essentially controls the execution of other computer programs, such as the scanning and capturing application 412, the detecting and capturing application 413, the order processing application 414, and provides scheduling, input-output control, file and data management, memory management, and communication control and related services.

Each of the scanning and capturing application 412, the detecting and capturing application 413, and the order processing application 414 may be a source program, executable program (object code), script, or any other entity comprising a set of instructions to be performed. When a source program, the program needs to be translated via a compiler, assembler, interpreter, or the like, which may or may not be included within the memory 404, so as to operate properly in connection with the O/S 416. Furthermore, each of the scanning and capturing application 412, the detecting and capturing application 413, and the order processing application 414 can be written as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada. In one embodiment, when installed within the memory 404 of the customer kiosk computer system 400, each of the scanning and capturing applications 412, the detecting and capturing application 413, and the order processing application 414 is written in C/C+/C++ format, and no browser-based software is used. In other embodiments, browser software may be used.

Each of the scanning and capturing applications 412, the detecting and capturing application 413, and the order processing application 414 can be implemented in software, firmware, hardware, or a combination thereof. In one mode, each of the scanning and capturing application 412, the detecting and capturing application 413, and the order processing application 414 is implemented in software, as an executable program, and is executed by one or more special or general purpose digital computer(s), such as a personal computer (PC; IBM-compatible, Apple-compatible, or otherwise), personal digital assistant, workstation, minicomputer, or mainframe computer. Therefore, the customer kiosk computer system 400 may be representative of any computer in which the scanning and capturing applications 412, the detecting and capturing application 413, and the order processing application 414 reside or partially reside. The customer kiosk computer system 400 can have one or more physical customer kiosks, which can take several different forms. In one form, the customer kiosk can be a free standing or stand-alone apparatus. In another form, the customer kiosk can be mounted to a counter-top instead of being a stand-alone apparatus. In either form, the customer kiosk can further include additional not-shown elements, such as a touch screen display, a credit card reader, and a receipt dispenser. The customer kiosk computer system 400 can be connected to a corresponding local vending establishment server computer 106 and to other local customer kiosk computer systems via a local area Ethernet communications network, as well as including a CD-ROM drive for uploading software applications and other information.

The I/O devices 406 may include input devices, for example but not limited to, credit card readers, input modules for PLCs, a keyboard, mouse, microphone, touch screens, interfaces for various devices, barcode readers, stylus, laser readers, radio-frequency readers, etc. Furthermore, the I/O devices 406 may also include output devices, including, but not limited to, receipt dispensers, output modules for PLCs, a printer, barcode printers, displays such as touch screen displays, etc. Finally, the I/O devices 406 may further include devices that communicate both inputs and outputs, for instance but not limited to, a modulator/demodulator (modem; for accessing another device, system, or network), a radio frequency (RF) or other transceiver, a telephonic interface, a bridge, and a router.

The barcode scanner 410 can be any one of known conventional barcode readers or scanners, which include sequential barcode scanners and charge-coupled device (“CCD”) barcode scanners. A sequential barcode scanner, for example, uses a scanning beam, typically narrow band light in the visible spectrum such as red laser, but potentially any bandwidth of light in the visible or infrared spectra, to pass over barcodes or optical machine-readable representations. The barcodes can be one-dimensional (1D) or two-dimensional (2D) barcodes. The 1D barcodes are typically represented by a sequence of dark bars or lines and spaces, and the 2D barcodes, also termed 2D matrix codes, are typically represented by patterns of squares, dots, hexagons and other geometric patterns. Another type of sequential scanner is a wand scanner, which is swept across the barcode by a user to create the scanning beam. As the scanning beam of light scans across the barcode, the beam is at least partially reflected back to the scanner by the spaces and is at least partially absorbed by the dark bars. A receiver, such as a photocell detector, in the scanner receives the reflected beam and converts the beam into an electrical signal. As the beam scans across the barcode, the scanner 410 typically creates a low electrical signal for the spaces, i.e., reflected beam, and a high electrical signal for the bars, i.e., where the beam is absorbed. The scanner may, however, create a low electrical signal for the bars and a high electrical signal for the spaces. The width of the bars and spaces determines the duration of the electrical signal. This signal is decoded by the scanner or by an external processor into characters that the barcode represents. In a CCD scanner, however, the scanner takes a digital image of the barcode and decodes the barcode using software that is well known in the art to convert the elements into the identification code. In either a sequential barcode scanner or a CCD scanner, the contrast between the bars and spaces is used to distinguish the elements and decode the barcode. A barcode displayed on an LCD screen such as on a PDA or cell phone, for example, has a contrast between the gray “off” state designating a space of the barcode and the black “on” state designating a bar than is available for a barcode printed on a black and white label. Recently, the airline transportation industry, namely the International Air Transport Association (AITA), in its aim to shift entirely to barcode boarding passes by 2010, has opted to standardize a mobile phone barcode system for customer check-ins at airports. The scanner 410 is configured to utilize this standard.

Alternatively, an RFID signal reader and an RFID transmitter can be utilized. Specifically, once generated by the signal generating application 321, the RFID signal can be transmitted for detection by the RFID signal reader 411 when the customer arrives at one of the vendor's establishments. The transmission of the generated RFID signal can be transmitted by an RFID transmitter or card, which can be built-in to the wireless mobile personal computer 102 or can be removably attached to it. The RFID signal is preferably a near field communication (NFC) signal. As known in the art, NFC is a short-range high frequency wireless communication technology which enables the exchange of data between devices over about a 10 centimeters (around 4 inches) distance. The technology is an extension of the ISO/IEC 14443 proximity-card standard (contactless card, RFID) that combines the interface of a smartcard and a reader into a single device. An NFC device can communicate with both existing ISO/IEC 14443 smartcards and readers, as well as with other NFC devices, and is thereby compatible with existing contactless infrastructure already in use for public transportation and payment. NFC is primarily aimed at usage in mobile phones. An example of an NFC RFID mobile add-on card is the iCarte, which as a reader and writer can provide NFC two way communications. For contactless payment capabilities, the iCarte has an embedded smart-chip, which can be configured as debit, credit, pre-paid and loyalty cards, thereby turning the IPHONE into an electronic wallet. The iCarte works with IPHONE 3G and 3GS with IPHONE OS 3.0 or above.

As discussed above, each one of the wireless mobile personal computers 102 includes a touch screen browser software application. In one embodiment, the touch screen browser application is provided for displaying a plurality of customer ordering interface screens of the present invention and receiving customer selections in response thereto, as will be described in greater detail below. In the embodiment shown in FIG. 2, the CPU portion 210 at least in part generates, launches, communicates, and/or implements the customer order generating interface screens for allowing and causing the touch screen browser application to display the customer order generating interface screens on the interactive hardware portion 204, for simplicity hereafter referred to as a touch screen display. As shown in FIGS. 2 and 3, the CPU portion 210 can include in memory 312 a restaurant order generating software application 318 for launching, communicating, and/or implementing the customer order generating interface screens of the present invention.

The customer can view the customer order generating interface screens as displayed on the touch screen display 204 by launching the customer order generating application 318, and the customer can utilize these customer order generating interface screens to select restaurant items, select a payment option, and generate a barcode or other code representative of the selected restaurant items and payment option. In one embodiment, the wireless mobile personal presentation on the touch screen display 204 is created and controlled by software, such as the customer order generating application 318 and information received from the CPU portion 210. When new software is to be installed on the wireless mobile personal computer 102, the software can be downloaded or retrieved from the database 112.

Now referring to FIG. 5, a flow chart 500 illustrates a process or method for establishing a customer account with the food vendor. In one embodiment, the customer must establish an account with the food vendor in order to receive and store the customer order generating application 318, the barcode generating application 320, the RFID signal generating application 321 and menu items including favorites and/or preferences. A barcode, created or generated by the barcode generating application 320, is configured to represent an order generated in the wireless mobile personal computer 102 and to include customer information needed to complete a purchase from the vendor at one of its vending establishments or restaurants. Alternatively, an RFID signal, created or generated by the RFID generating application 321, is configured to represent an order generated in the wireless mobile personal computer 102, and can be configured to include customer information needed to complete a purchase from the vendor at one of its vending establishments or restaurants.

The customer account is opened or set up as follows. The customer accesses a food vendor's website using the Internet and a computer running a web browser program, at step 502. The computer may be the wireless mobile personal computer 102 or any other computer with access to the Internet. After connecting to the food vendor's website, the customer begins the account set-up by following procedures provided on related web pages of the web site, at step 504. Typically, in setting up an account the customer is requested to choose a user name and password and then enter personally identifying information such as a name, a mailing address, an e-mail address, and/or a phone number, as generally shown in step 506. After choosing a user name, a password, and entering personally identifying information, the customer is further requested to enter payment options information, which can include cash and electronic payments (epayment). The epayment option can be at least one of a credit card number representing a chargeable credit card account associated with the customer, a debit card number representing a debitable bank account associated with the customer, a chargeable vendor's card account associated with the customer, such as the McDonald's Arch Card, or a payment service account number such as a “PayPal” account number representing a chargeable PayPal account associated with the customer. The vendor's card is typically only valid and accepted for use at the vendor's participating restaurants. Once the account is validated, the customer is provided for downloading or retrieving from the database 112 the restaurant order generating application 318, the barcode generating application 320, the RFID signal generating application 321, and selectable menu item preferences, such as menu favorites. As generally shown in step 508, based on the provided customer information, customer identification is generated by a corresponding customer application running on the vendor server computer 104 for storage in the vendor database 112 and in the wireless database 314. If the customer account is created using a computer other than the wireless mobile personal computer 102, the customer identification, the menu items including favorites and/or preferences, the restaurant order generating application 318, the barcode generating application 320, and the RFID signal generating application 321 can be first downloaded to and stored in this other computer and then to the wireless mobile personal computer 102. After the download, the customer can log off of the food vendor's website, and is ready to begin using the invention to generate restaurant orders on the wireless mobile personal computer 102 and purchase them at the vendor's participating establishments.

In a further embodiment, the customer does not need to establish a customer account in order to be able to download menu items, the restaurant order generating application 318, the barcode generating application 320, and the RFID signal generating application 321 to the wireless mobile personal computer 102. The customer can access the food vendor's website and select the information and the applications 318, 320 and 321 for download to the wireless mobile personal computer 102. Alternately, the customer can download any of these applications or “App” directly from a third party, such as Apple iTunes or Google App Store, or such as from an App developer site. A link could be provided form the food vendor's website in order to have the customer redirected to where the App is located for downloading.

The computer networked system 100 allows customers to create a food order before arriving at a quick service restaurant, such as a McDonald's restaurant. This is achieved by accessing or launching the restaurant order generating application 318 on the client mobile personal computer 102. The customer then selects items to generate an order through interface screens generated by the order generating application 318 through the client mobile personal computer 102. A barcode or other code is then generated by the barcode generating application 320 and presented on the screen to use to place the order when the customer arrives at one of the vendor's local restaurants or establishments. As such, upon arrival at the restaurant, the customer places the order by scanning the order barcode at the customer kiosk scanner 410 that submits the order and payment information to the restaurant. If the customer has an account with the vendor r has otherwise directly provided payment information to the applications 318, 320 and 321, the barcode generated will include a payment method chosen by the customer, via i.e., epayment or cash. Otherwise, the generated barcode will not include any payment information, and the customer will pay for his order as he/she chooses after scanning the generated barcode. The customer can check in at the drive-thru, inside, or at a designated curbside parking space depending on where the barcode scanner 410 is located. The food is then prepared and presented in a typical fashion, or walked to the customer's car at curbside.

Alternately, once the order is created an RFID signal is then generated by the RFID signal generating application 321 and transmitted to place the order when the customer arrives at one of the vendor's local restaurants or establishments. As such, upon arrival at the restaurant, the customer places the order by transmitting the order RFID signal for detection by the RFID signal reader 411, which submits the order and payment information to the restaurant. If the customer has an account with the vendor or has otherwise directly provided information to the applications 318, 320, and 321, the generated RFID signal will include a payment method chosen by the customer, via i.e., epayment or cash. If the customer does not have an account with the vendor, the generated RFID signal will not include any payment information, and the customer will pay for his order as he/she chooses after transmitting the generated RFID signal. The customer can check in at the drive-thru, inside, or at a designated curbside parking space depending on where the RFID reader 411 is located. The food is then prepared and presented in a typical fashion, or walked to the customer's car at curbside. In one embodiment, both the barcode and the RFID signal can be compressed by the barcode generating application 320 and the RFID signal generating application 321. Once captured by the scanning and capturing application 412 or the detecting and capturing application 413, the compressed barcode or RFID signal is then decompressed by the order processing application 414 before being processed.

Specifically, with reference to FIGS. 6A-6O and FIGS. 7A-7S, to be discussed in detail below, the order generating interface screens provide four main options for order creation: 1) single order for pickup at Drive-Through (DT); 2) single order for pickup in-store; 3) group order for pickup at Drive-Through (DT); and 4) group order for pickup in-store. Referring to FIGS. 6A-6O and FIG. 8, customer ordering interface screens 600 are displayed on the display 204 of the wireless mobile personal computer 102 and representing a single order option in accordance with the invention. It should be understood that when the term “barcode” is referenced, the term “RFID” can be utilized as well, including at least the barcode itself and the barcode scanner. In one embodiment, the customer order generating application 318 can be configured to carry out the method 800 shown in FIG. 8. Specifically the method 800 can generate and display an opening customer ordering interface screen 602, at Step 802, which allows the customer to begin the generation of the order. Referring to FIG. 6A, the opening customer ordering interface screen 602 can be configured to display four selectors 602 A-D, one for each the above discussed four options for order creation, namely single or group order for Drive-Through or pickup in-store. If the customer selects the single order for pickup at Drive-Through selector 602A or the single order for pickup in-store selector 602B, which selection is then received by the order generating application 318, the customer ordering interface screen 604 followed by the customer ordering interface screen 606 will be transmitted to and displayed on the display 204, at Steps 804 and 806. Referring to FIG. 6C, the restaurant order generating application 318 is configured to display a My Menu selector 606A, a My Barcodes selector 606B and a My Settings selector 606C on the interface screen 606 for selection by the customer. After the My Menu selector 606A is selected, the customer order generating application 318 can be configured to generate and display the interface screen 608, shown in FIG. 6D, which allows the customer to select a specific restaurant location at which the customer would like to place and pickup the order. The interface screen 608 provides a choice between a “Saved Location” selector 608A and a “Nearest Location” selector 608B. When the “Saved Location” selector 608A has been selected and the selection is received by the order generating application 318, the order generating application 318 is configured to transmit and display, one or more maps showing restaurant locations, previously saved in the memory 212, along with their respective addresses on the display 204. When the “Nearest Location” selector 608B has been selected, similarly the order generating application 318 transmits and displays one or more maps showing restaurant locations are displayed based on a zip code entered by the customer or on a global positioning system (GPS) application that determines the closest restaurant locations relatively to the location of the wireless mobile personal computer 102. Once a desired or specific location is chosen by selecting one of the “button” selector 608C or 608D associated with one of the displayed maps, and selecting the “Select This Location” selector 608E, the customer order generating application 318 can be configured to receive the selection and generate and display the interface screen 610 shown in FIG. 6E, or other order entry interface screens that allows the customer to select restaurant items as part of the order being generated. Interface screens similar to those disclosed in US Patent Application Publication No. 2009/0265247, the contents of which are herein incorporated by reference, can be generated and provided to allow for selecting and customizing restaurant items. In addition, as generally shown in interface screen 610 and discussed above, the customer can be provided with options by the order generation application 318 to select and store his/her favorite menu items and favorite orders, which can then be used to select in an expedited manner for future ordering. As shown, the interface screen 610 allows the customer to select and edit their favorite orders by selecting the “Edit My Fav” selector 610A, and add it to the order by selecting the “Add to Order” selector 610B, at Step 808. FIG. 6F shows a further customer ordering interface screen 612 generated and transmitted for display by the order generating application 318 after receiving the customer selection of the “Add to Order” selector 610B. This interface screen 612 provides input options to edit the selected menu items by selecting the “Edit” selector 612A, to add order items via the “Add item” selector 612B, and a pay option via the “Pay” selector 612C, at Step 810. Once the customer selects to pay, the customer order generating application 318 receives the items and the payment selection and generates and displays the interface screen 614 shown in FIG. 6G. The selection of items received by the order generating application 318 includes a “Quarter Pounder w/Cheese” selection, a “Medium French Fries” selection and a “Medium Coke” selection. After receiving the item and payment selection, the order generating application 318 is configured to generate and transmit for display the interface screen 614 shown in FIG. 6G. The interface screen 614 provides payment options, such as via a Visa Card, an Arch Card for McDonald's, and pay on site at the restaurant selected. Additionally, the customer order generating application 318 can be configured to offer the customer to add another payment option by selecting the “Add Payment Method” button on interface 614. Once the payment option has been selected, at Step 812, the customer can select the “Create BarCode” selector 614A to be received by the barcode generating application 320 which then generates a barcode representative of the generated order, which includes the menu items and the payment option selected, at Step 814.

Referring to FIGS. 6H and 6I, once the barcode is generated, the customer order generating application 318 is configured to generate, transmit and display for the customer interface screens 616 and 618 which include directions on where to place the order by presenting the created barcode, pay for the order and pick up the generated order. Each of interface screens 616 and 618 include a map on how to move through a “speaker-post” kiosk (in-store pickup or hand delivery to the customer's car) and on how to check-in using the drive-through, as shown on FIGS. 6H and 6I, respectively. The interface screens 616 and 618 can also provide a selectable option to display the created barcode to use when the customer arrives at the restaurant location, specifically at a customer kiosk of the restaurant location. Once the barcode option selection has been received, the customer order generating application 318 can be configured to generate, transmit and display the created bar code on interface screen 620 shown in FIG. 6J. When the customer arrives at the restaurant, the barcode scanner 410, which can be within the customer kiosk, hand-held and used by a food runner/presenter, or within some other device, such as a “speaker post,” is provided for scanning and capturing the barcode displayed on the interface screen 620, at Step 816. Once at or presented with the scanner 410, the customer can position the barcode displayed on the display of the wireless mobile personal computer 102 to be read and captured by the scanner 410. After capturing the displayed barcode, the scanning and capturing application 412 is configured to decode the barcode to figure out what items have selected by the customer and coded by the barcode generating application 320, as well as the payment information if one was selected and included in the barcode. The decoded barcode is then communicated to the customer order processing application 414 which processes the order, communicates the items ordered to the local kitchen for preparation, and processes the payment method selected by the customer. If an epayment has been selected, the customer order processing application 414 is configured to process electronically the payment and inform the cashier or runner that the payment has been provided. The prepared order is then provided to the customer through the drive-through window, the walk-up counter, or delivered to the customer waiting in the parking lot. If the “I'll Pay Onsite” option is selected from within the payment interface screen 614 during the order generating process, the customer must also provide payment on-site (drive-through, walk-up, or with a food runner having a payment receiving device, such as a handheld credit card scanner) prior to receiving the prepared order.

Referring to FIGS. 6K-6O, the customer order generating application 318 is configured to further generate, transmit and display interface screens 622-630 which enable the customer to recall barcodes which have been placed, so that the wireless mobile personal computer 102 can be used for other functions prior to arrival at the restaurant location. As shown in FIG. 6M, the displayed interface screen 626 allows the customer to select “My Barcodes” selector 626B in order to show orders that have been placed for the respective ordering methods shown in FIG. 6K, namely single order for pickup at Drive-Through (DT) 622A, single order for pickup in-store 622B, group order for pickup at Drive-Through (DT) 622C, and group order for pickup in-store 622D. The barcode for the selected ordering method will then be displayed by interface screen 628 shown in FIG. 6N. The interface screen 628 also provides the customer with the option of re-displaying the items ordered within a receipt by selecting the “Receipt” selector 628A, at Step 818. Following receipt of the selection of the “Receipt” selector 628A, the customer order generating application 318 is configured to generate and display the interface screen 630 shown in FIG. 6O, which also provides the total amount paid for the generated order, the payment option used to pay for the order, as well as a statement that the receipt can be accessed in the customer account.

Now referring to FIGS. 7A-7C, upon receipt of the customer selection of either the group order for pickup at Drive-Through selector 702C or the group order for pickup in-store selector 702D of interface screen 702, the customer order generating application 318 is configured to generate and display the interface screen 704 followed by the interface screen 706 shown in FIGS. 7B and 7C, respectively. The interface screen 706 allows for a customer to select a My Menu selector 706A, a My Barcodes selector 706B or a My Settings selector 706C. Upon receipt of the My Menu selector 706A selection, the customer order generating application 318 can be configured to generate and display the interface screen 708 shown in FIG. 7D, which allows the customer to select a specific restaurant location at which the customer would like to place and pickup the order. The interface 708 provides a choice between a “Saved Location” selector 708A and a “Nearest Location” selector 708B. When the “Saved Location” selector 708A has been selected, one or more maps showing restaurant locations, previously saved in the memory 212, are displayed along with their respective addresses. When the “Nearest Location” selector 708B has been selected, which selection is then received by the order generating application 318, similarly one or more maps showing restaurant locations will be generated and transmitted for display based on a zip code entered by the customer or on a global positioning system (GPS) application that determines the closest restaurant locations relatively to the location of the wireless mobile personal computer 102. Once a desired or specific location is chosen by selecting one of the “button” selector 708C or 708D associated with one of the displayed maps, and selecting the “Select This Location” selector 708E, the customer order generating application 318 can be configured, upon receipt of the selection, to generate and display the interface screen 710 shown in FIG. 7E, or other order entry interface screens, that allows the customer to select restaurant items as parts of the order being generated. In addition, as generally shown in interface screen 710 and discussed above, the customer can be provided with options to select and store his/her favorite menu items and favorite orders, which can then be used to select in an expedited manner for future ordering. As shown, the interface screen 710 allows the customer to select and edit their favorite orders by selecting the “Edit My Fav” selector 710A, and add it to the order by selecting the “Add to Order” selector 710B.

FIG. 7F shows a further customer ordering interface screen 712, generated and transmitted by the order generating application 318 for display after receiving the customer selection of the “Add to Order” selector 710B. The interface screen 712 is provided to allow the customer to select restaurant items for a first person of the group. The interface screen 712 also provides the customer an option to add another person to the order by selecting the “Add Person” selector 712A, or an option to pay by selecting the “Pay” selector 712B. Once the “Add Person” selection in made within the interface screen 712 of FIG. 7F and received by the order generating application 318, an interface screen 714 as shown in FIG. 7G, is generated and transmitted for display to enable the customer to select menu items for a second person of the group. The interface screen 714 also provides the customer an option to add another person to the order by selecting the “Add Person” selector 714A, or an option to pay by selecting the “Pay” selector 714B. Upon receipt of the “Add Person” selection within the interface screen 714 of FIG. 7G, the order generating application 318 is configured to generate, transmit and display interface screen 716 shown in FIG. 7H, which allows the customer to select menu items for a third person of the group. The interface screen 716 also provides the customer an option to add another person to the order by selecting the “Add Person” selector 716A, or an option to pay by selecting the “Pay” selector 716B.

Referring to FIG. 7I, in response to the customer selection of the “Pay” option from any one of the interface screens of FIG. 7F, 7G or 7H, a further interface screen 718, shown in FIG. 7J, is generated, transmitted and displayed by the order generating application 318 to provide a summary of the group order and total price for the order, and also allows the customer to select the “Save Group” selector 718A and store the group order, and to select the “Pay” selector 718B to pay for the group order. If the “Pay” selector 718B has been selected, in response to the selection the customer order generating application 318 can be configured to generate and display interface screen 720 shown in FIG. 7J, which provides various options for payment, such as by credit card, by a vendor or loyalty payment card, such as an Arch Card for McDonald's, and pay on site at the restaurant selected in interface screen 708. Additionally, the customer order generating application 318 can be configured to offer the customer to add another payment option by selecting the “Add Payment Method” button. Once the payment option has been selected, the customer can select the “Create BarCode” selector 720A. The barcode selection is then received by the barcode generating application 320, which is configured to generate a barcode representative of the generated order, which includes the group menu items and a payment option selected.

Referring to FIGS. 7K and 7L, in response to the creation of the barcode, the customer order generating application 318 is configured to generate, transmit and display interface screens 722 and 726 which include directions on where to present the created barcode and pick up the generated order. Each of interface screens 722 and 726 includes a map on how to move through a “speaker-post” kiosk (in-store pickup or hand delivery to the customer's car) and on how to check-in using the drive-through, as shown on FIGS. 6H and 6I, respectively. The interface screens 722 and 726 can also provide a selectable option to display the created barcode to use when the customer arrives at the restaurant location, specifically at a customer kiosk of the restaurant location. Upon receipt of the barcode option selection, the customer order generating application 318 can be configured to generate, transmit and display the interface screens 724 and 728 shown in FIGS. 7L and 7N, respectively, which display the created barcode. When the customer arrives at the restaurant, the barcode scanner 410, which can be within the customer kiosk, hand-held and used by a food runner/presenter, or within some other device, such as a “speaker post,” is provided for scanning and capturing the barcode displayed on the interface screens 724 and 728. Once at or presented with the scanner 410, the customer can position the barcode displayed on the display of the wireless mobile personal computer 102 to be read and captured by the scanner 410. After capturing the displayed barcode, the scanning and capturing application 412 is configured to decode the barcode to figure out what items have selected by the customer and encoded by the barcode generating application 320, as well as the payment information if one was selected and included in the barcode. The decoded barcode is then communicated to the customer order processing application 414 which processes the order, communicates the items ordered to the local kitchen for preparation, and processes the payment method selected by the customer. If an epayment has been selected, the customer order processing application 414 is configured to process electronically the payment and inform the cashier or runner that the payment has been provided. The prepared order is then provided to the customer through the drive-through window, the walk-up counter, or delivered to the customer waiting in the parking lot. If the “I'll Pay Onsite” option is selected from within the payment interface screen 720 during the order generating process, the customer must also provide payment on-site (drive-through, walk-up, or with a food runner having a payment receiving device, such as a handheld credit card scanner) prior to receiving the prepared order

Similarly to FIGS. 6K-6O, referring to FIGS. 7O to 7S, the customer order generating application 318 generates and transmits for display interface screens 622-630 which allow for the customer to recall barcodes which have been placed, so that the wireless mobile personal computer 102 can be used for other functions prior to arrival at the restaurant location. As shown in FIG. 7Q, the provided interface screen 734 allows the customer to select “My Barcodes” selector 734B in order to show orders that have been placed for the respective ordering methods shown in interface screen 730 of FIG. 7O, namely single order for pickup at Drive-Through (DT) 730A, single order for pickup in-store 730B, group order for pickup at Drive-Through (DT) 730C, and group order for pickup in-store 730D. After receipt of ordering method selection, the interface 736, generated and transmitted for display by the order generating application 318, will include the corresponding barcode, as shown in FIG. 7R. The interface screen 736 also provides the customer with the option of re-displaying the items ordered within a receipt 738A in interface screen 738 by selecting the “Receipt” selector 736A. Following the selection of the “Receipt” selector 736A, the customer order generating application 318 is configured to generate and display the interface screen 738, shown in FIG. 7S, which also provides the total amount paid for the generated group order, the payment option used to pay for the group order, as well as a statement that the receipt can be accessed in the customer account.

As suggested above, as additional alternatives, both single and group orders could also be placed for pickup at a curbside kiosk which is equipped with scanner 410 which scans the barcode and include information about the selected payment method, such as epayment or pay onsite. A food runner would then provide the order to the customer at curbside when the order is ready. The Drive-Thru Check-In is configured to fit into existing drive-thru flows without interrupting the existing customer experience or store operations. Check-In can occur at existing order “speaker posts.” A second, dedicated Scanning Station kiosk can also be provided, when needed for any particular restaurant. All payment types (cash, cards, and epayments) could be accepted at each location. As mentioned above, “EPayment” is defined as either a credit card, debit card, or Arch Card number stored using the pre-established the user's McDonald's account. EPayment through the wireless mobile personal computer 102 allows the customer to skip the pay window/station.

When a customer does Inside Check-In, there are two options available. The first inside Check-In option is going to a Scanning Station kiosk, which includes a scanner 410, next to a register (not shown). As discussed above, after the barcode is scanned, the order proceeds as a regular order does, with the crewmember (cashier/runner/presenter) confirming the order, processing payment, and directing the customer to pick up their order at the presentment counter. Cash, cards and ePayment can all be accepted. Alternatively, the wireless mobile personal computer 102 can display this information and act as a pager to notify the customer when their order is ready. The customer then proceeds to pick up his or her order from the presentment counter. The second Inside Check-In opinion is a Scanning Station kiosk, which also includes a scanner 410, located on the customer's path from the entrance to the presentment counter (i.e., near the entrance or at the presentment counter) (i.e., near the entrance or at the present counter). ePayment is required to use this station. When the customer scans the generated barcode at this station, audible or visual confirmation is given that Check-In was received. The Station prints a receipt that includes the customer's order, payment confirmation, and order number. Again, as an alternative, the wireless mobile personal computer 102 can display this information and act as a pager to notify the customer when the order is ready. The customer then proceeds to pick-up the order from the presentment counter.

It should be noted that one form that one form of the barcode scanner 410 and/or barcode generating application 320 can be “2D code generators for i-mode” provided by NTT DOCOMO, Inc., a subsidiary of NTT Japan. In an RFID embodiment, it should be understood that scanning may take place as soon as the RFID tag is within a predetermined distance from the RFID scanner. When a scan occurs, the scanning station can be configured to automatically place an order or place the order after payment information is received and/or the customer confirms the order.

Any process descriptions or blocks in figures, such as FIGS. 5, 6A-6O, 7A-7S and 8, should be understood as representing modules, segments, or portions of code which include one or more executable instructions for implementing specific logical functions or steps in the process, and alternate implementations are included within the scope of the embodiments of the present invention in which functions may be executed out of order from that shown or discussed, including substantially concurrently or in reverse order, depending on the functionality involved, as would be understood by those having ordinary skill in the art.

It should be emphasized that the above-described embodiments of the present invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

1. A wireless mobile personal computer for enabling a customer to generate a restaurant order on the wireless mobile personal computer, comprising:
a restaurant order generating application configured to generate restaurant item selecting interface screens for generating the restaurant order comprising at least one restaurant item, to generate a machine-readable representation of the generated restaurant order;
a processor for executing the restaurant order generating application;
a memory for storing the restaurant order generating application and selectable restaurant items; and
a display for displaying the restaurant item selecting interface screens and the at least one restaurant item,
wherein the wireless mobile personal computer is configured to provide the machine-readable representation of the generated order to an order processing system for placement at the restaurant order.

2. The wireless mobile personal computer according to claim 1, wherein the machine-readable representation of the generated order is an optical machine-readable representation.

3. The wireless mobile personal computer according to claim 1, wherein the machine-readable representation of the generated order is a radio transmittable representation.

4. The wireless mobile personal computer according to claim 3, further comprising a transmitter for transmitting the radio transmittable representation of the generated restaurant order.

5. The wireless mobile personal computer according to claim 1, wherein the machine-readable representation of the generated restaurant order is stored in the memory of the wireless mobile personal computer.

6. The wireless mobile personal computer according to claim 2, wherein the optical machine-readable representation is a barcode.

7. The wireless mobile personal computer according to claim 6, wherein the barcode is either a one-dimensional barcode or a two-dimensional barcode.

8. The wireless mobile personal computer according to claim 3, wherein the radio transmittable representation is a radio-frequency identification.

9. The wireless mobile personal computer according to claim 1, wherein the restaurant order generating application is further configured to generate the restaurant order within the wireless mobile personal computer without communication with a remote computer.

10. The wireless mobile personal computer according to claim 1, wherein the restaurant order generating application is further configured to generate the machine-readable representation within the wireless mobile personal computer without communication with a remote computer.

11. The wireless mobile personal computer according to claim 2, wherein the optical machine-readable representation is displayed on the display for scanning by a scanner of a customer kiosk, wherein the customer kiosk is part of the order processing system.

12. The wireless mobile personal computer according to claim 4, further wherein the radio transmittable representation is transmitted by the transmitter for detection by a radio-frequency receiver of a customer kiosk, wherein the customer kiosk is part of the order processing system.

13. The wireless mobile personal computer according to claim 11, wherein the customer kiosk further comprises:
a scanning application configured to scan and capture the optical machine-readable representation;
a kiosk processor for executing the scanning application; and
a kiosk memory for storing the scanning application.

14. The wireless mobile personal computer according to claim 12, wherein the customer kiosk further comprises:
a radio-frequency detecting application configured to detect and capture the radio transmittable representation;
a kiosk processor for executing the detecting application; and
a kiosk memory for storing the detecting application.

15. The wireless mobile personal computer according to claim 13, wherein the customer kiosk further comprises a display.

16. The wireless mobile personal computer according to claim 11, wherein the customer kiosk is in communication with a vendor system.

17. The wireless mobile personal computer according to claim 16, wherein the vendor system comprises:
an account establishing application configured to establish a customer account;
a vendor system processor for executing the account establishing application;
a vendor system memory for storing the account establishing application; and
a database for storing customer accounts.

18. The wireless mobile personal computer according to claim 17, wherein the customer account comprises customer information and customer payment options.

19. The wireless mobile personal computer according to claim 18, wherein the customer information comprises at least one of a name of the customer, an e-mail address of the customer, and/or a phone number of the customer.

20. The wireless mobile personal computer according to claim 18, wherein the customer payment options comprise at least one of a credit card number representing a chargeable credit card account associated with the customer, a debit card number representing a debitable bank account associated with the customer, a payment service number representing a payment service account associated with the customer, and/or currency.

21. The wireless mobile personal computer according to claim 17, wherein the customer account is established through execution of the account establishing application through the wireless mobile personal computer.

22. The wireless mobile personal computer according to claim 18, wherein the machine-readable representation comprises the customer information.

23. The wireless mobile personal computer according to claim 18, wherein the machine-readable representation comprises at least one of the customer payment options.

24. A computer readable medium encoded with a restaurant order generating computer program application configured to generate a restaurant order on a wireless mobile personal computer, the wireless mobile personal computer having a processor for executing the restaurant order generating application, a memory for storing the restaurant order generating application and selectable restaurant items, and a display, the restaurant order generating computer program application comprising:
a first code segment for generating restaurant item selecting interface screens;
a second code segment for receiving a selection of at least one restaurant item;
a third code segment for generating a restaurant order from the selection of the at least one restaurant item; and
a fourth code segment for generating a machine-readable representation of the generated restaurant order.

25. The computer readable medium according to claim 24, wherein the machine-readable representation of the generated order is an optical machine-readable representation.

26. The computer readable medium according to claim 24, wherein the machine-readable representation of the generated order is radio transmittable representation.

27. The computer readable medium according to claim 25, further comprising a fifth code segment for displaying the optical machine-readable representation on the display.

28. The computer readable medium according to claim 26, further comprising a sixth code for transmitting the radio transmittable representation via a transmitter.

29. The computer readable medium of claim 24, further comprising:
an seventh code segment for storing the machine-readable representation of the generated restaurant order in the memory of the wireless mobile personal computer.

30. The computer readable medium of claim 24, wherein the third code segment generates the restaurant order within the wireless mobile personal computer without communication with a remote computer.

31. The computer readable medium of claim 24, wherein the fourth code segment generates the machine-readable representation within the wireless mobile personal computer without communication with a remote computer.

32. A system for enabling a customer to generate an order, the system comprising:
a wireless mobile personal computer for enabling a customer to generate a restaurant order on the wireless mobile personal computer, comprising:
a restaurant order generating application configured to generate restaurant item selecting interface screens for generating the restaurant order comprising at least one restaurant item, and to generate a machine-readable representation of the generated restaurant order;
a processor for executing the restaurant order generating application;
a memory for storing the restaurant order generating application and selectable restaurant items; and
a display for displaying the restaurant item selecting interface screens and the at least one restaurant item;
a customer kiosk for capturing the machine-readable representation; and
a vendor system in communication with the customer kiosk, comprising;
an account establishing application configured to establish a customer account;
a vendor system processor for executing the account establishing application;
a vendor system memory for storing the account establishing application; and
a database for storing customer accounts.

33. The system according to claim 32, wherein the machine-readable representation of the generated order is an optical machine-readable representation.

34. The system according to claim 32, wherein the machine-readable representation of the generated order is a radio transmittable representation.

35. The system according to claim 34, wherein the wireless mobile personal computer further comprises a transmitter for transmitting the radio transmittable representation of the generated restaurant order.

36. The system according to claim 34, wherein the customer kiosk further comprises a scanner, wherein the scanner comprises a scanning application configured to scan and capture the optical machine-readable representation, a kiosk processor for executing the scanning application, and a kiosk memory for storing the scanning application,

37. The system according to claim 35, wherein the customer kiosk further comprises an RFID signal receiver, wherein the RFID signal receiver comprises a detecting application configured to detect and capture the radio transmittable representation, a processor for executing the detecting application, and a memory for storing the detecting application.
